(19) United States
(12) Patent Application Publication
(10) Pub. No.: US 2014/0297927 A1
(43) Pub. Date: Oct. 2, 2014

(54) INFORMATION PROCESSING APPARATUS, INFORMATION PROCESSING METHOD, AND RECORDING MEDIUM

(71) Applicant: Sony Corporation, Tokyo (JP)

(72) Inventors: Tomohiro KATORI, Tokyo (JP); Satoru IWASAKI, Tokyo (JP); Hiroki NAGAHAMA, Tokyo (JP)

(73) Assignee: Sony Corporation, Tokyo (JP)

(21) Appl. No.: 14/193,090

(22) Filed: Feb. 28, 2014

(30) Foreign Application Priority Data
Mar. 28, 2013 (JP) 2013-070440

(51) Int. Cl. G06F 12/02

(52) U.S. Cl. CPC G06F 12/0246
USPC 711/103

(57) ABSTRACT

An information processing apparatus includes a main storage device, in which the main storage device includes a non-volatile storage unit and a volatile storage unit, and a page is moved between the non-volatile storage unit and the volatile storage unit at a predetermined timing based on a priority that is assigned to the page.

### CROSS REFERENCE TO RELATED APPLICATIONS

This application claims the benefit of Japanese Priority Patent Application JP 2013-070440 filed Mar. 28, 2013, the entire contents of which are incorporated herein by reference.

### BACKGROUND

The present technology relates to an information processing apparatus, an information processing method, and a recording medium. Specifically, the present technology relates to an information processing apparatus capable of shortening time for transition to a state such as a suspend state or the like, an information processing method, and a recording medium.

Various types of personal computers such as desktop computers, notebook computers and tablet computers, smartphones, and mobile terminals have come into wide use. The personal computers such as notebook computers and tablet computers, mobile terminals and the like are a battery driven type which also can be driven by a battery included therewithin, and have structures that can be being carried easily.

A battery driving time is limited and various methods for power saving have been proposed to extend the battery driving time. The power saving has been realized not only for the mobile terminals but also for the desktop personal computers.

As one method for power saving, a method in which power supply to a part or the entire system is properly reduced or cut off in response to a reduction in a system usage situation can be considered. However, since a task is interrupted from power cutoff, it is necessary to save system state information before the power is cut off and restore the saved state information when the power is re-supplied so that the task can be restarted from the time point at which the task has been interrupted when the power is re-supplied. An operation of saving the system state information and interrupting the task is referred to as “suspend” and an operation of restoring the state information and restarting the task is referred to as “resume.”

There may be two methods for realizing the suspend and resume functions. One is a method in which power is continuously supplied to a volatile main storage device or the like before and after the power of a terminal is cut off to hold system state information. In addition, the other is a method in which, when power is cut off, system state information that is decompressed in a main storage device or the like is stored in a non-volatile secondary storage device and the saved state information is restored in the main storage device or the like when the power is re-supplied.

In the former method, the system state information is stored in the battery-backed-up volatile main storage device or the like. Therefore, saving and restoration processes of the terminal are performed at a very high speed, but the power is consumed for a memory holding operation by the main storage device when the terminal is stopped. Thus, a power saving effect is low. On the other hand, in the latter case, since the system state information necessary for restarting a task is stored in the non-volatile secondary storage device, the power can be cut off in almost all of components in the terminal and a power saving effect is high.

However, the access rate of a hard disk drive (or a flash memory) as the secondary storage device is generally lower than that of the main storage device. If a process operation of storing or decompressing a memory image in the main storage device in the secondary storage device is included, a defect such as the operation taking too much time occurs.

As described above, since the main storage device of the system is volatile, it is necessary to save the content of the main storage device in the secondary storage device to transit the system state to a suspend state by cutting off the entire power of the system, including the main storage device (process referred to as suspend to disk or hibernation).

Contrarily, there has been proposed a method in which time necessary for a suspend process is shortened by using a non-volatile device in a part of a main storage device without saving data in a non-volatile storage unit (for example, refer to Japanese Unexamined Patent Application Publication No. 2004-362426).

### SUMMARY

In Japanese Unexamined Patent Application Publication No. 2004-362426, the priority is assigned to pages that are necessary for a resume process and the pages are moved to a non-volatile storage unit in descending order of priority during suspend execution. At this time, pages, which are not able to be stored in the non-volatile storage unit and overflow, are moved to a secondary storage device. Then, in the resume process, the pages stored in the secondary storage device are read by a volatile storage unit.

However, in Japanese Unexamined Patent Application Publication No. 2004-362426, since paging is performed from the volatile storage unit to the non-volatile storage unit to the secondary storage device during the suspend execution, it is difficult to shorten time to save the pages. For example, if there are a large number of pages placed in the volatile storage unit, there are a large number of pages to be moved during the suspend process and it takes a long time to move the pages. Therefore, it is difficult to shorten time to save the pages.

Since an effect of power saving or the like can be expected by shortening time for a suspend process, shortening time for the suspend process has been demanded.

It is desirable to shorten time for a suspend process.

According to an embodiment of the present technology, there is provided an information processing apparatus including a main storage device, in which the main storage device has a non-volatile storage unit and a volatile storage unit, and a page is moved between the non-volatile storage unit and the volatile storage unit based on a priority that is assigned to the page at a predetermined timing.

A page placed in the non-volatile storage unit may be a page that has a high possibility of being accessed after resume execution.

The information processing apparatus may further include a first list for managing priorities of pages having a high possibility of being accessed after resume execution, and a second list for managing priorities of pages having a low possibility of being accessed after resume execution.

The first list may be stored in the volatile storage unit but may be a list for managing high priority pages to be moved to the non-volatile storage unit, and the second list may be stored in the non-volatile storage unit but may be a list for managing high priority pages to be moved to the volatile storage unit.

The first list and the second list may be updated when an event in which a system state changes occurs.

The event may be at least one event of activation or end of a predetermined application, start or end of use of a predetermined device, switching to a predetermined mode, a change in positional information, and a change in a network connection state.

The predetermined timing may be timing at which the first list and the second list are updated.

The information processing apparatus may further include a third list for managing probabilities that a predetermined application calls other applications, and a profile for managing page information necessary for a predetermined application after resume execution, in which when a screen by a first application is changed to a screen by a second application, the profile may be referred to confirm a page necessary for the second application after resume execution, and the third list may be referred to assign a probability of the second application to the confirmed page, and the first list and the second list may be respectively updated based on a value of the probability assigned to the page.

A page movement frequency between the non-volatile storage unit and the volatile storage unit may be changed according to the number of pages written in the first list or the second list.

According to another embodiment of the present technology, there is provided an information processing method of an information processing apparatus that includes a main storage device having a non-volatile storage unit and a volatile storage unit including moving a page between the non-volatile storage unit and the volatile storage unit at a predetermined timing based on a priority that is assigned to the page.

According to still another embodiment of the present technology, there is provided a computer-recording recording medium having a program recorded therein, the program causing a computer, which controls an information processing apparatus that includes a main storage device having a non-volatile storage unit and a volatile storage unit, to execute a process including moving a page between the non-volatile storage unit and the volatile storage unit at a predetermined timing based on a priority that is assigned to the page.

In the information processing apparatus, the information processing method, and the recording medium according to the embodiments of the present technology, the main storage device includes the non-volatile storage unit and the volatile storage unit, and a page is moved between the non-volatile storage unit and the volatile storage unit at a predetermined timing based on a priority that is assigned to the page.

According to the embodiments of the present technology, it is possible to shorten time for a suspend process.

### BRIEF DESCRIPTION OF THE DRAWINGS

FIG. 1 is a diagram illustrating an example of an information processing apparatus in the related art;

FIG. 2 is a flow chart for illustrating a suspend process in the related art;

FIG. 3 is a diagram illustrating a configuration of an embodiment of an information processing apparatus to which the present technology is applied;

FIG. 4 is a diagram illustrating a function of the information processing apparatus;

FIG. 5 is a diagram for illustrating a page movement;

FIG. 6 is a diagram for illustrating a page movement;

FIG. 7 is a flow chart for illustrating a suspend process;

FIG. 8 is a diagram for illustrating a page priority update timing;

FIG. 9 is a diagram illustrating another configuration of the information processing apparatus;

FIGS. 10A and 10B are diagrams for illustrating a page movement rate;

FIG. 11 is a diagram for illustrating a page priority setting method;

FIGS. 12A and 12B are diagrams for illustrating an application profile;

FIG. 13 is a flow chart for illustrating a page priority setting method;

FIG. 14 is a flow chart for illustrating a priority update process;

FIG. 15 is a flow chart for illustrating a page movement instruction; and

FIG. 16 is a diagram for illustrating a recording medium.

### DETAILED DESCRIPTION OF EMBODIMENTS

Embodiments for carrying out the present technology (hereinafter, referred to as “embodiments”) will be described hereinafter. Description will be made in the following order.

1. Suspend Process in Related Art

2. Configuration of Information Processing Apparatus according to First Embodiment to which Present Technology is Applied

3. Suspend Process in First Embodiment

4. Configuration of Information Processing Apparatus according to Second Embodiment

5. Priority Assignment Process in Second Embodiment

6. Regarding Other Configurations

7. Regarding Recording Medium

### Suspend Process in Related Art

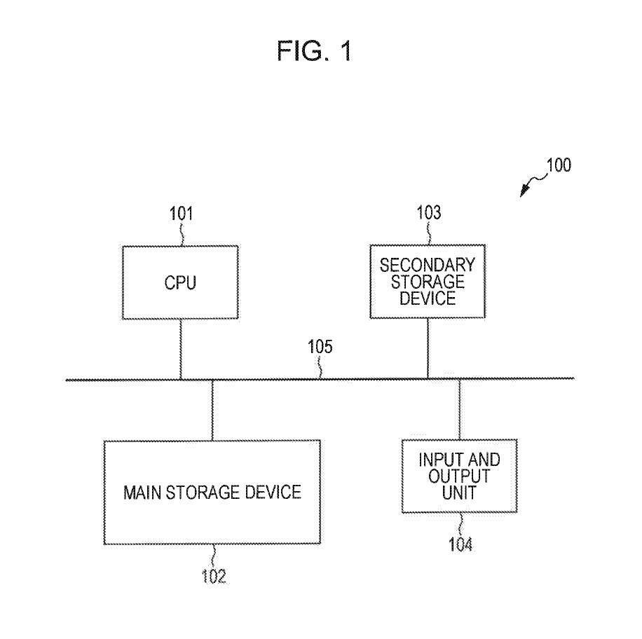

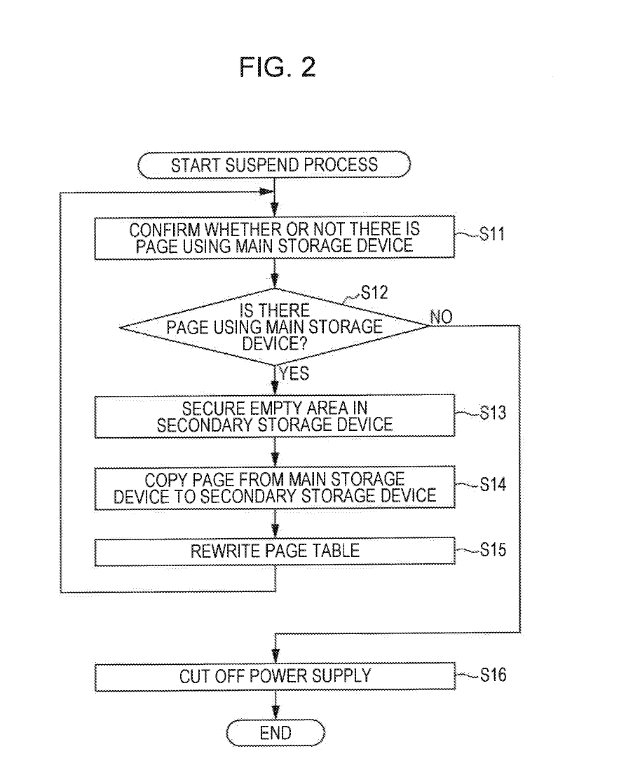

First, an information processing apparatus of the related art and a suspend process in the information processing apparatus will be described to clear the difference between the present technology and the related art. FIG. 1 is a view illustrating a configuration of the information processing apparatus of the related art, and FIG. 2 is a flow chart for illustrating a suspend process in the information processing apparatus illustrated in FIG. 1.

The information processing apparatus 100 illustrated in FIG. 1 includes a central process unit (CPU) 101, a main storage device 102, a secondary storage device 103, an input and output unit 104, and a system bus 105.

The CPU 101 executes various types of programs under the control of an operating system (OS). The CPU 101 controls each unit in the information processing apparatus 100 through the system bus 105 which is a common signal transmission path formed of a data signal line, an address signal line, a control signal line, and the like.

The main storage device 102 loads each program (OS, application program or the like) executed by the CPU 101 or is used as an operation area by the CPU 101. The secondary storage device 103 is configured with a non-volatile storage unit such as a hard disk drive (HDD) or a flash memory. The access rate of the secondary storage device 103 is lower than that of the main storage device 102, but the secondary storage device has a large capacity and is provided to assist the main storage device 102.

The HDD is an external storage unit in which a magnetic disk is mounted in a fixed manner and is superior to other disk type storage devices such as a CD, a DVD and the like in terms of a storage capacity and a data transfer rate. Usually, program codes of an operating system, an application program, a device driver, and the like, which are to be executed by the CPU 101, are stored in the HDD in a non-volatile manner.

The input and output unit 104 includes a user input device such as a keyboard or a mouse, an output device such as a display and a printer, a connection interface with a network device, other external devices thereof, and the like. Drawing data on a display is once written in a video RAM (VRAM) (not illustrated) and then, output on the display.

A unique address (I/O address) in an I/O space is allocated to each device on the system bus 105, and access to each device is realized by designating the I/O address. In addition, a bus interface of each device includes an I/O register (not illustrated), and data or a command to be written to each device, data to be read from each device, a device state, and the like are once written to the I/O register and then, bus transfer is performed.

In the configuration of the information processing apparatus 100 illustrated in FIG. 1, configurations necessary for the following description is illustrated and configurations for realizing other functions are not illustrated.

With reference to the flow chart in FIG. 2, the suspend process in the information processing apparatus 100 illustrated in FIG. 1 will be described.

In Step S11, a managed page table is confirmed and it is confirmed whether or not there is a virtual page using the main storage device 102. In Step S12, as a result of the confirmation in Step S11, it is determined whether or not there is the virtual page using the main storage device 102. In Step S12, if it is determined that there is the virtual page using the main storage device 102, the process proceeds to Step S13. If the virtual page using the main storage device 102 is found, a process for saving the page in the secondary storage device 103 starts.

In Step S13, an empty area in the secondary storage device 103 is secured to save the virtual page using the main storage device 102. For example, the empty area in the secondary storage device 103 is secured such that a swap management function of the operating system searches an unused area for one page from a swap area.

In Step S14, the page using the main storage device 102 is saved in the secured empty area in the secondary storage device 103. For example, the above-described swap management function is performed by copying the page to the secured empty area.

In Step S15, the page table is updated and a virtual address mapping the saved page is invalidated. Further, the saved page is released and is recognized as an empty area.

By repeating the processes from Step S11 to Step S15 until there is no page using the main storage device 102, the pages using the main storage device 102 are saved.

Then, in Step S12, if it is determined there is no page using the main storage device 102, the process proceeds to Step S16 to cut off the power of the system.

The suspend process is performed as described above, and the saved data is returned to the main storage device 102 from the secondary storage device 103 during resume execution to thereby restore the system to a state before the power is cut off.

Since the suspend process is performed as described above, in a case in which the amount of data using the main storage device 102 is large when the suspend process starts, it takes a long time to save data using the secondary storage device 103. That is, if the process in Step S13 or Step S14 is repeated, it takes time to end the suspend process.

For example, if a user gives a suspend instruction and tries to confirm that the power is cut off, it takes a long time from the instruction to the power cutoff, and thus, the user may possibly become impatient. In addition, if the user gives the suspend instruction erroneously, a resume instruction is given after the suspend execution ends. After the system is restored to the state before the suspend execution starts, it is determined that correct instructions are given. However, it takes time during the processes, and thus, the user may possibly become impatient similar to the above-described case.

Further, if the time when the information processing apparatus 100 is not used is set as a suspend state, a power saving effect can be expected. However, if it takes time until the suspend process ends, the power saving effect thereof is attenuated. For this reason, there is a possibility that the suspend execution itself may not be used. Therefore, it is possible to reduce these possibilities by shortening time for the suspend execution. Then, the embodiment of the present technology that can shorten time for the suspend process will be described below. Configuration of Information Processing Apparatus according to First Embodiment to which Present Technology is Applied

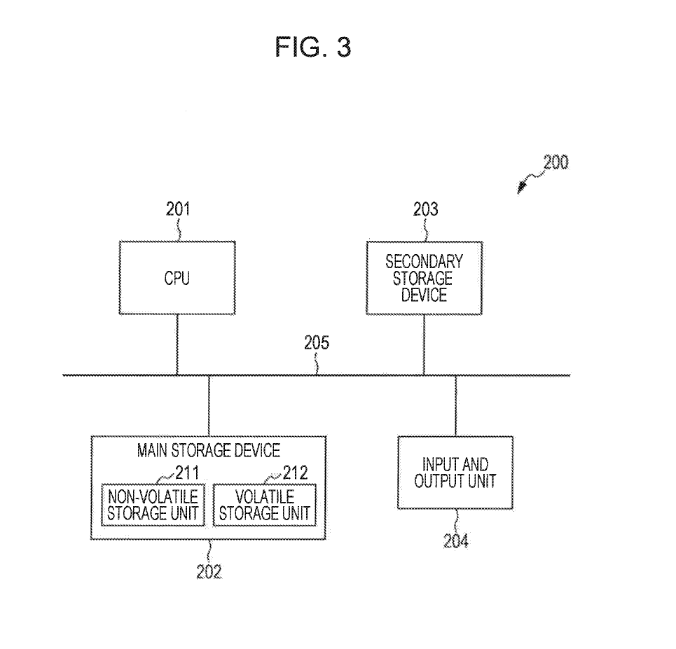

FIG. 3 is a view illustrating a hardware configuration of an information processing apparatus according to a first embodiment to which the present technology is applied. The information processing apparatus 200 illustrated in FIG. 3 includes a CPU 201, a main storage device 202, a secondary storage device 203, an input and output unit 204, and a system bus 205. In addition, the main storage device 202 of the information processing apparatus 200 illustrated in FIG. 3 has a non-volatile storage unit 211 and a volatile storage unit 212.

Examples of the information processing apparatus 200 include various types of personal computers such as desktop computers, notebook computers and tablet computers, smart phones, and mobile terminals.

The CPU 201 executes various types of programs under the control of an operating system (OS). The CPU 201 controls each unit in the information processing apparatus 200 through the system bus 205 which is a common signal transmission path formed of a data signal line, an address signal line, and a control signal line.

The main storage device 202 loads each program (OS, application program or the like) executed by the CPU 201 or is used as an operation area by the CPU 201. The secondary storage device 203 is configured with a non-volatile storage unit such as a hard disk drive (HDD) or a flash memory. The access rate of the secondary storage device 203 is lower than that of the main storage device 202, but the secondary storage device has a large capacity and is provided to assist the main storage device 202.

The input and output unit 204 includes a user input device such as a keyboard or a mouse, an output device such as a display or a printer, a connection interface with a network device and other external devices thereof, and the like. Drawing data on a display is once written in a video RAM (VRAM) (not illustrated) and then, output on the display.

A unique address (I/O address) in an I/O space is allocated to each device on the system bus 205, and access to each device is realized by designating the I/O address. In addition, a bus interface of each device includes an I/O register (not illustrated), and data or a command to be written to each device, data to be read from each device, a device state, and the like are once written to the I/O register and then, bus transfer is performed.

In the configuration of the information processing apparatus 200 illustrated in FIG. 2, configurations necessary for the following description is illustrated and configurations for realizing other functions is not illustrated.

The information processing apparatus 100 illustrated in FIG. 1 is compared with the information processing apparatus 200 illustrated in FIG. 3. The main storage device 102 of the information processing apparatus 100 of the related art illustrated in FIG. 1 is different from the main storage device 202 of the information processing apparatus 200 illustrated in FIG. 3 in that while the main storage device 120 is configured with the volatile storage unit, the main storage device 202 is configured with the non-volatile storage unit 211 and the volatile storage unit 212.

The non-volatile storage unit 211 is an area in the main storage device 202 in which data does not disappear even when the power of the information processing apparatus 200 is cut off. Specifically, a device using a non-volatile memory element such as a MRAM or a ReRAM may be used.

The magnetic RAM (MRAM) is configured with a tunneling magneto resistive (TMR) element using a tunneling magneto resistive effect and is capable of holding information by using spin of electrons instead of using electric charge of electrons. The MRAM satisfies most of conditions as the main storage device 202 in terms of an access rate of rewriting, reading or the like, a degree of integration, power consumption, unit of bits or the like, and also has a feature of non-volatility.

In addition, the resistance RAM (ReRAM) is a non-volatile memory that uses a change in electric resistance by voltage application, and since rewriting is performed by voltage (the amount of current is very small), power consumption is low. Also, since a cell area is small and densification can be achieved, the ReRAM satisfies most of conditions as the main storage device similar to the MRAM. Accordingly, specifically, the device using the non-volatile memory element such as the MRAM or the ReRAM is used in the non-volatile storage unit 211 of the main storage device 202, but it should be noted that the configuration is merely an example and the configuration is not limited thereto.

Further, the non-volatile storage unit can also be realized by attaching a backup battery to a device using a volatile memory element such as a dynamic random access memory (DRAM) as the non-volatile storage unit 211 of the main storage device 202.

Unlike the non-volatile storage unit 211, the volatile storage unit 212 is an area in the main storage device 202 in which data disappears when the power of the information processing apparatus 200 is cut off.

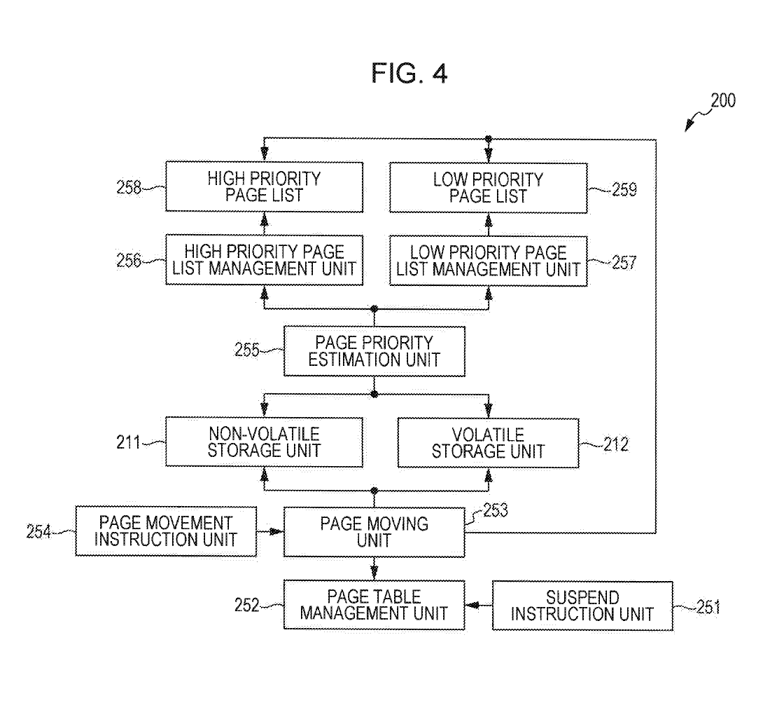

FIG. 4 is a functional block diagram of the information processing apparatus 200 having the hardware configuration illustrated in FIG. 3. The hardware configuration of the information processing apparatus 200 illustrated in FIG. 4 is illustrated together with functions that are realized by executing a predetermined program by the CPU 201.

The information processing apparatus 200 illustrated in FIG. 4 includes the non-volatile storage unit 211, the volatile storage unit 212, a suspend instruction unit 251, a page table management unit 252, a page moving unit 253, a page movement instruction unit 254, a page priority estimation unit 255, a high priority page list management unit 256, a low priority page list management unit 257, a high priority page list 258, and a low priority page list 259.

The non-volatile storage unit 211 and the volatile storage unit 212 are the non-volatile storage unit 211 and the volatile storage unit 212 illustrated in FIG. 3.

When the user gives a suspend instruction by operating the input and output unit 204 (FIG. 3), the suspend instruction unit 251 notifies the start of a suspend process to a place in which the suspend process is to be performed.

The page table management unit 252 manages a page table for mapping a physical address and a virtual address. The page table is a reference table for converting a virtual address to a physical address by a memory management unit (MMU), and plural page tables are present in every virtual address space. When the page moving unit 253 moves a page, the page table management unit receives physical addresses of a movement source and a movement destination of the page to update data of the page table mapping the physical addresses. When the start of the suspend process is notified by the suspend instruction unit 251, a virtual address mapping the volatile storage unit 212 is invalidated.

The page moving unit 253 moves the page between the non-volatile storage unit 211 and the volatile storage unit 212 at a timing at which an instruction is given from the page movement instruction unit 254. The page managed in the high priority page list 258 is moved to an empty area of the non-volatile storage unit 211. If there is no empty area to move a high priority page, the page managed in the low priority page list 259 is moved to the volatile storage unit 212, and an empty area is formed in the non-volatile storage unit 211.

The page movement instruction unit 254 gives a page movement instruction to the page moving unit 253. Since the page movement is performed during a normal operation of the information processing apparatus 200, the page movement is performed at a timing at which a main function is not heavily and adversely affected. For example, if the utilization of the CPU 201 (FIG. 3) is equal to or less than a predetermined rate, the page movement is performed.

The page priority estimation unit 255 estimates the priority of the page which is present in the main storage device 202. If an event in which the page priority changes occurs, the page priority is dynamically recalculated. If the page priority is changed, as a result of the recalculation, an instruction is given to the high priority page list management unit 256 and the low priority page list management unit 257 to update the page lists which are respectively managed by the high priority page list management unit and the low priority page list management unit.

The page priority is changed when a pattern of the page to be accessed by the system after resume execution is significantly changed. For example, if a new application is activated, there is a high possibility that the application may continuously operate after resume execution. Therefore, a page that is used by the application is set to have high priority.

The high priority page list management unit 256 updates the content of the high priority page list 258 based on the instruction of the page priority estimation unit 255. The high priority page list management unit 256 adds a page of which the priority becomes higher to the list and deletes a page of which the priority becomes lower from the list.

The low priority page list management unit 257 updates the content of the low priority page list 259 based on the instruction of the page priority estimation unit 255. The low priority page list management unit 257 adds a page of which the priority becomes lower to the list and deletes a page of which the priority becomes higher from the list.

The high priority page list 258 is a list for managing pages to be moved to the non-volatile storage unit 211 among the pages stored in the volatile storage unit 212. The page to be moved to the non-volatile storage unit 211 refers to a page in which, when suspend and resume processes are performed from this point on, data with a high possibility of being accessed immediately after the resume execution is stored.

If these pages are present in the volatile storage unit 212, the data is saved in the secondary storage device 203 before the power of the main storage device 202 is cut off in the suspend process. Immediately after the resume execution, the pages are not present in the main storage device 202. If these pages are not present in the main storage device 202 immediately after the resume execution, it is necessary to read the pages from the secondary storage device 203 and the process may not be continuously performed until the reading ends.

In order to perform the system operation at a high speed immediately after the resume execution, it is necessary to hold these pages in the non-volatile storage unit 211 so that these pages are accessible immediately after the resume execution. That is, these pages have high arrangement priorities in the non-volatile storage unit 211.

The low priority page list 259 is a list for managing pages which may be moved to volatile storage unit 212 among the pages stored in the non-volatile storage unit 211. The page which may be moved to the volatile storage unit 212 refer to a page in which, when suspend and resume processes occur from this point on, data with a low possibility of being accessed immediately after the resume execution is stored.

Since these pages are not accessed immediately after the resume execution, these pages may be read from the secondary storage device 203 to main storage device 202 when the pages are necessary. Accordingly, even if the pages are moved to the volatile storage unit 212 during the system operation and saved in the secondary storage device 203 in the suspend process, the operation rate of the system immediately after resume execution is not affected. That is, these pages have low priorities to be arranged in the non-volatile storage unit 211.

In the information processing apparatus 200 having such a configuration, the page which has to be stored in the main storage device 202 during resume execution is stored in the non-volatile storage unit 211 in advance during the operation of the information processing apparatus 200 (before the suspend started). Therefore, after the suspend process ends and the power is cut off, the page stored in the non-volatile storage unit 211 is still stored and the saved page can be referred to restore the system to a state before the power is cut off during resume execution.

In addition, at a time point before the suspend process starts, a page which has to be saved during suspend execution is stored in the non-volatile storage unit 211, and thus, it is possible to reduce time to save the page and time for the suspend process can be shortened.

Therefore, the pages are stored in the non-volatile storage unit 211 and the volatile storage unit 212 during the operation of the information processing apparatus 200. At this time, the page with a high possibility of being accessed immediately after the resume execution is stored in the non-volatile storage unit 211, and the page with a low possibility of being accessed immediately after the resume execution is stored in the volatile storage unit 212.

For example, if a page is moved during a suspend process, the page may be moved based on the priority that can be set at a time point when the suspend process starts. However, if a page is moved at a time point before the suspend process starts, in other words, during the operation of the information processing apparatus 200, the priority is not uniquely determined and is changed depending on situations.

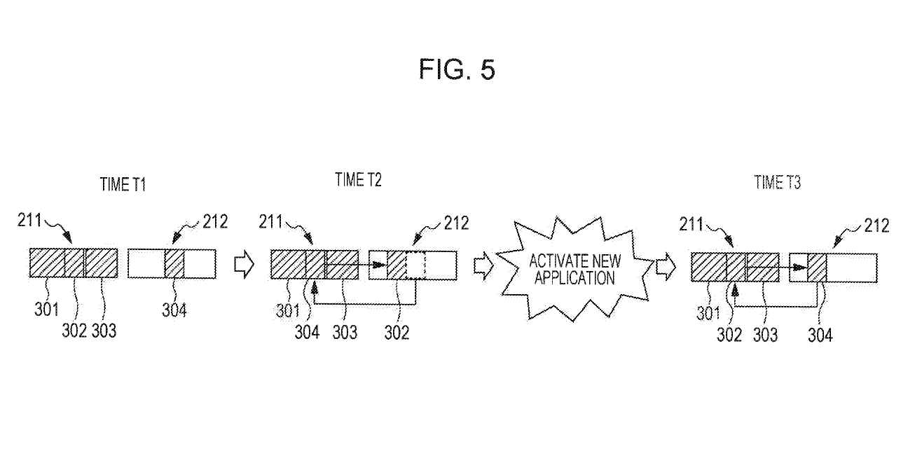

That is, since the information processing apparatus 200 continues the operation even after the page is moved based on the priority at an arbitrary time point, the priority may be changed in some cases until the suspend process starts. The change will be described with reference to FIG. 5.

FIG. 5 is a view schematically illustrating pages that are stored respectively in the non-volatile storage unit 211 and the volatile storage unit 212 in time T1, time T2, and time T3 during the operation of the information processing apparatus 200.

At the time T1, a page 301, a page 302 and a page 303 are stored in the non-volatile storage unit 211, and a page 304 is stored in the volatile storage unit 212. As described above, the pages stored in the non-volatile storage unit 211 are high priority pages, and the pages 301, 302 and 303 are set to have high priority at the time T1. In addition, the page stored in the volatile storage unit 212 is a low priority page and the page 304 is set to have low priority at the time T1.

At the time T2, the priority is changed and the page 302 which has been set to have high priority is reset to have low priority, and the page 304 which has been set to have low priority is reset to have high priority.

For example, since the priority of the page 304 is changed from low to high by activating an application using the page 304, a storage destination is changed from the volatile storage unit 212 to the non-volatile storage unit 211. At this time, if there is no capacity for storing the page 304 in the non-volatile storage unit 211, the priority of the page 302 is changed from high to low and a storage destination is changed from the non-volatile storage unit 211 to the volatile storage unit 212. Then, an empty area is formed in the non-volatile storage unit 211 by moving the page 302 from the non-volatile storage unit 211 to the volatile storage unit 212 and thus, the page 304 is moved to the area.

After such a page movement is performed at the time T2, a new application is activated at the time T3, and the newly activated application is an application for referring the page 302.

At the time T2, the priority of the page 302 is changed from high to low and the storage of the page 302 is changed to the volatile storage unit 212. However, since the page 302 is a page referring the newly activated application, the priority is changed from low to high again. As a result, the page 304 is moved from the volatile storage unit 212 to the non-volatile storage unit 211, and the page 304 is moved to the volatile storage unit 212 from the non-volatile storage unit 211.

As described above, while the information processing apparatus 200 is operated, the priority of the page is dynamically changed according to the activation or the end of the application. The dynamic change is managed by the high priority page list management unit 256 and the low priority page list management unit 257 using the high priority page list 258 and the low priority page list 259.

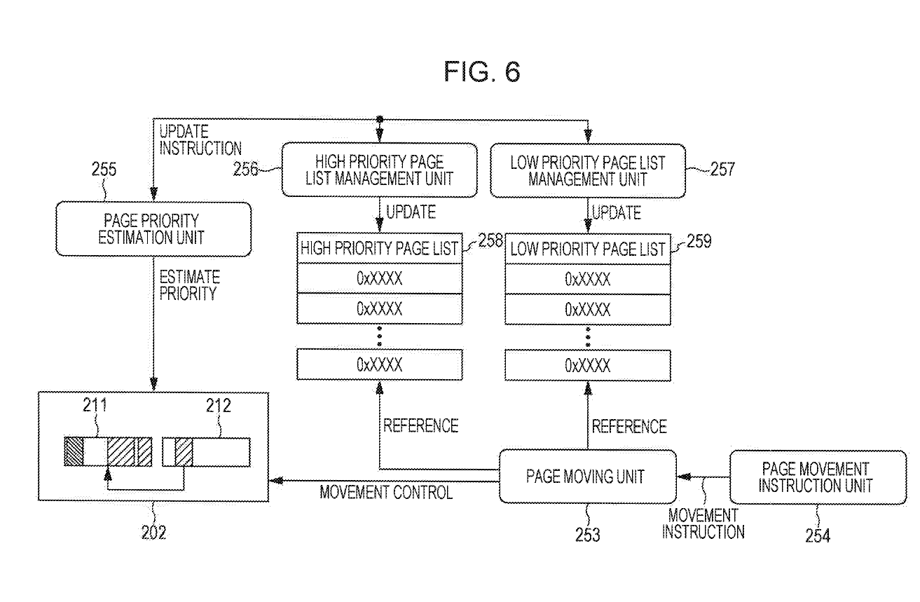

The management will be described with reference to FIG. 6. The priorities of the pages stored in the main storage device 202 are estimated by the page priority estimation unit 255. The priorities based on the estimation of the page priority estimation unit 255 are assigned to the pages in the main storage device 202 and are managed as the high priority page list 258 or the low priority page list 259. The page priority estimation unit 255 determines the priorities of the pages in consideration of accessibility after resume execution and a state change of the information processing apparatus (system) 200 from this point on.

The high priority page list 258 is provided to manage the high priority pages placed in the volatile storage unit 212, and the low priority page list 259 is provided to manage the low priority pages placed in the non-volatile storage unit 211. In other words, the high priority pages to be moved from the volatile storage unit 212 to the non-volatile storage unit 211 are managed in the high priority page list 258, and the high priority pages to be moved from non-volatile storage unit 211 to the volatile storage unit 212 are the low priority page list 259.

The page moving unit 253 moves the high priority page in the volatile storage unit 212 to the non-volatile storage unit 211, and moves the high priority page in the non-volatile storage unit 211 to the volatile storage unit 212 based on the instruction from the page movement instruction unit 254, or with reference to the high priority page list 258 and the low priority page list 259c.

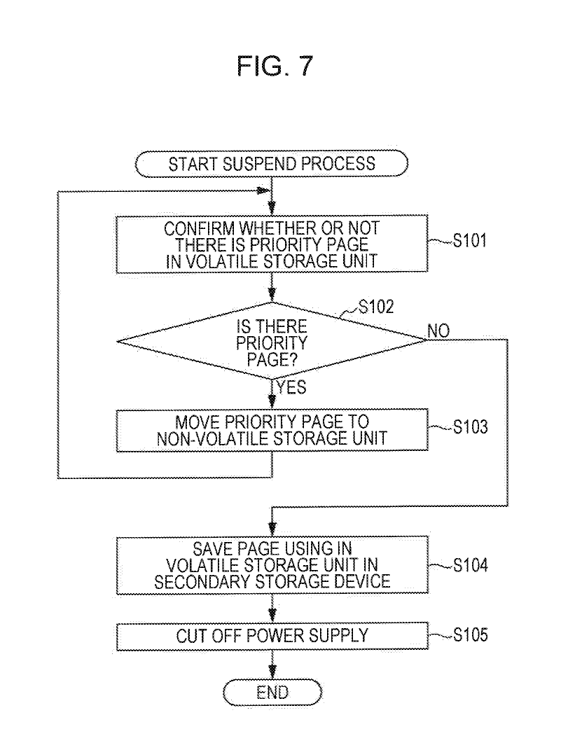

As described above, since the high priority page, that is, that the page with a high possibility of being necessary after resume execution to the non-volatile storage unit 211 is stored in non-volatile storage unit 211 according to the priority, the process of moving the page with a high possibility of being necessary after resume execution can be omitted during suspend execution. Therefore, it is possible to shorten time for the suspend process. With regard to this, a description will be made with reference to a flow chart of FIG. 7.

### Suspend Process in First Embodiment

FIG. 7 is a flow chart for illustrating a process during the suspend process of the information processing apparatus 200 illustrated in FIGS. 3 and 4. For example, the suspend process is executed when the user gives a suspend instruction by operating the input and output unit 204 of the information processing apparatus 200.

In Step S101, the page moving unit 253 confirms the high priority page list 258 and also confirms whether or not a high priority page remains in the volatile storage unit 212. In Step S102, it is determined whether or not the high priority page remains the volatile storage unit 212 using the confirmation result.

In Step S102, if it is determined that a high priority page remains in the volatile storage unit 212, the process proceeds to Step S103. In Step S103, the high priority page that has been determined to remain in the volatile storage unit 212 is saved in the non-volatile storage unit 211.

The page moving unit 253 moves the high priority page in the volatile storage unit 212 to the non-volatile storage unit 211. The page moving unit 253 secures an empty area in the non-volatile storage unit 211 to move the high priority page. If there is no empty area in the non-volatile storage unit 211, the page which is set as a low priority page is moved from the non-volatile storage unit 211 to the volatile storage unit 212 by referring to the low priority page list 259 and thus, an empty area is formed.

The data of the high priority page is copied to the empty area that is secured by the page moving unit 253. When the copy is completed, the page table management unit 252 updates the page table so that a virtual address mapping the movement source page refers to the movement destination page. The high priority page list management unit 256 deletes the moved page from the high priority page list 258. In addition, if there is a page moved to secure a capacity of the non-volatile storage unit 211 among the pages written in low priority page list 259 to secure a capacity of the non-volatile storage unit 211, the low priority page list management unit 257 deletes the page from the low priority page list 259.

After the page which is set as a high priority page is moved from the volatile storage unit 212 to the non-volatile storage unit 211, the process returns to Step S101 and the following processes are repeated. That is, if the high priority page remains in the volatile storage unit 212, the process of moving the page to the non-volatile storage unit 211 is repeated.

On the other hand, in Step S102, if it is determined that there is no high priority page in the volatile storage unit 212, the process proceeds to Step S104. In Step S104, the page (data) remaining in the volatile storage unit 212 is saved in the secondary storage device 203. In the saving, for example, a kernel swap mechanism is used and the page is copied (swapped out) to the secondary storage device 203.

As described above, if the page stored in the volatile storage unit 212 is saved in the non-volatile storage unit 211 or the secondary storage device 203 during the suspend process, the power is cut off in Step S105.

In this manner, the suspend process is executed.

Here, the suspend process of the related art illustrated in FIG. 2 is compared with the suspend process according to the present technology illustrated in FIG. 7. According to the suspend process of the related art illustrated in FIG. 2, the process of securing an empty capacity of the secondary storage device 103 in Step S13, and the process of copying the page from the main storage device 102 to the secondary storage device 103 in Step S14 are included.

According to the suspend process according to the present technology illustrated in FIG. 7, processes corresponding to the processes executed in Step S13 and Step S14 are Step S102, Step S103, and Step S104.

According to the related art, Step S13 and Step S14 have to be performed. The process executed in Step S14 is a process which takes time since writing to the secondary storage device 203 is performed at a low access rate.

In Step S102 and Step S103, the page that is set as a high priority page is moved from the volatile storage unit 212 to the non-volatile storage unit 211, but most of the pages that are set as high priority pages are already stored in the non-volatile storage unit 211 at a time point before the suspend process starts.

That is, since the high priority pages are moved to the non-volatile storage unit 211 during the operation of the information processing apparatus 200 in the above-described embodiment, basically, the high priority page does not remain in the volatile storage unit 212 when the suspend process starts. Therefore, except for a case in which the high priority pages are not completely moved during normal operation, it is determined that the high priority page does not remain in the volatile storage unit 212 in Step S102, and the process in Step S103 is not executed.

In addition, there is an exception that the high priority pages are not completely moved during normal operation. However, in this case, since some of the high priority pages are moved, the number of processes of moving the page from the volatile storage unit 212 to the non-volatile storage unit 211 in Step S103 is small. That is, even in the exception, the number of page movements can be reduced.

Therefore, it is possible to remarkably shorten time for the process of moving the page from the volatile storage unit 212 to the non-volatile storage unit 211.

Further, in Step S104, the process of saving the page using the volatile storage unit 212 in the secondary storage device 203 is executed, but the number of the pages using the volatile storage unit 212 is small at the time point when the process in Step S104 is executed. Therefore, in Step S104, even if the data is written to the secondary storage device 203 which has a low access rate occurs, there are few writing pages (data amount) and thus, it is possible to shorten time for the writing.

For this reason, it is possible to remarkably shorten the time for the process of moving the page from the volatile storage unit 212 to the secondary storage device 203. As a result, the time from the start of the suspend process based on the flow chart illustrated in FIG. 7 to the end of the suspend process can be shortened.

Further, the page with a high possibility of being necessary during resume execution is stored in the non-volatile storage unit 211 at the time point when the suspend process is instructed. Therefore, during resume execution, it is possible to remarkably shorten the time for restoring the system to the time point before the suspend process starts.

In addition, even immediately after the restoration, since the page with a high possibility of being necessary during resume execution is already stored in the non-volatile storage unit 211, a process of moving the page from the secondary storage device 203 to the volatile storage unit 212 is not necessary and after the restoration, the operation can be immediately started. Therefore, it is possible to increase the operation rate immediately after the restoration.

Further, even if the process of moving the page from the secondary storage device 203 to the volatile storage unit 212 is necessary, the page stored in the secondary storage device 203 is a page with a low possibility of being necessary during resume execution. Thus, it is possible to start the process by using the page stored in the non-volatile storage unit 211. Then, after the process starts, even if the page is moved from the secondary storage device 203 to the volatile storage unit 212 as necessary, the process is not delayed. Therefore, it is possible to increase the operation rate immediately after the restoration.

### Configuration of Information Processing Apparatus According to Second Embodiment

In the first embodiment, it has been described that the pages are stored in the non-volatile storage unit 211 and the volatile storage unit 212 in the main storage device 202 depending on the priority during the operation of the information processing apparatus 200 and thus, the time for the suspend process is shortened.

However, as illustrated in FIG. 5, if the priority is assigned to the pages during the operation of the information processing apparatus 200, and the pages are stored in the non-volatile storage unit 211 or the volatile storage unit 212 depending on the priority, the priority is dynamically changed according to the activated application. That is, there is a possibility of frequently moving the pages simply by setting the priority of the page to be accessed after resume execution high, and there is also a possibility of an unnecessary increase in the number of page movements.

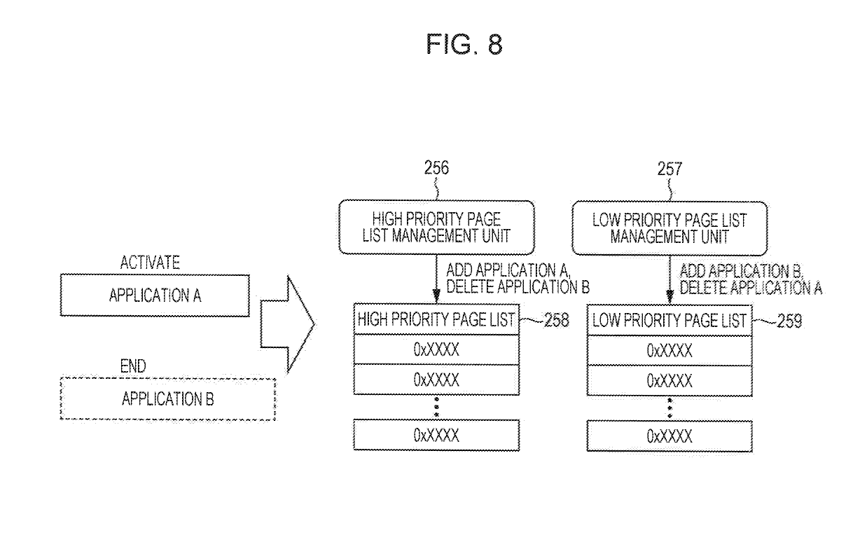

Here, as described below, a frequent page movement is prevented even during the operation of the information processing apparatus 200, and an unnecessary increase in the number of page movements can be prevented. As an example, a description will be made with reference to FIG. 8 in a case in which the activation or the end of the application is used as a trigger to update the high priority page list 258 and the low priority page list 259.

The page priority estimation unit 255 dynamically estimates the priority of a page according to a system (information processing apparatus 200) state. If the priority is changed, an update instruction for the high priority page list 258 and the low priority page list 259 is given respectively to the high priority page list management unit 256 and the low priority page list management unit 257.

The priority is changed is at the time when an even that the pattern of the page to be accessed after resume execution is remarkably changed occurs. Here, the activation or the end of the application is mentioned as an example of the event and the description will continue using a case in which the priority is determined using the activation or the end of the application as a key as an example.

As illustrated in FIG. 8, if a new application A is activated, it is possible to estimate that the application A has a high possibility of operating after resume execution. Accordingly, the page which will be used by the application A but is stored in the volatile storage unit 212 now is moved to the non-volatile storage unit 211.

In order to perform such a process, the high priority page list management unit 256 adds the page to be used by the application A after resume execution to the high priority page list 258 and the low priority page list management unit 257 deletes the page to be used by the application A is deleted from the low priority page list 259.

In addition, as illustrated in FIG. 8, if an activated application B ends, it is possible to estimate that the application B has a low possibility of operating for a predetermined period from this point on. Therefore, the page which is placed in the non-volatile storage unit 211 to be used by the application B after resume execution is moved to the volatile storage unit 212.

In order to perform such a process, the high priority page list management unit 256 deletes the page that has been used by the application B from the high priority page list 258, and the low priority page list management unit 257 adds the page that has been used by the application B and will be used after resume execution to the low priority page list 259.

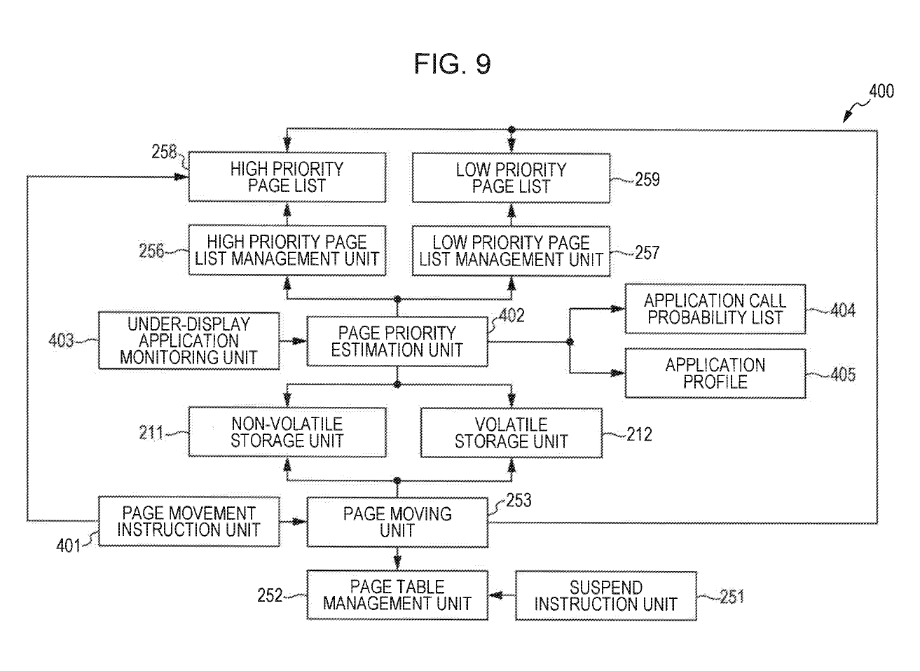

As described above, when the event such as the activation or the end of a predetermined application occurs, in case of the configuration in which the high priority page list 258 or the low priority page list 259 is updated, the configuration of the information processing apparatus 200 is configured as illustrated in FIG. 9. Here, in order to make a difference between the information processing apparatus 200 illustrated in FIG. 9 and the information processing apparatus 200 illustrated in FIG. 4, the information processing apparatus illustrated in FIG. 9 is referred to as a information processing apparatus 400.

The information processing apparatus 400 illustrated in FIG. 9 includes the non-volatile storage unit 211, the volatile storage unit 212, the suspend instruction unit 251, the page table management unit 252, the page moving unit 253, the high priority page list management unit 256, the low priority page list management unit 257, the high priority page list 258, the low priority page list 259, a page movement instruction unit 401, a page priority estimation unit 402, an under-display application monitoring unit 403, an application call probability list 404, and an application profile 405.

The non-volatile storage unit 211, the volatile storage unit 212, the suspend instruction unit 251, the page table management unit 252, the page moving unit 253, the high priority page list management unit 256, the low priority page list management unit 257, the high priority page list 258, and the low priority page list 259 in the information processing apparatus 400 are the same as the corresponding units in the information processing apparatus 200 illustrated in FIG. 4.

The page movement instruction unit 401 and the page priority estimation unit 402 in the information processing apparatus 400 are basically the same as the page movement instruction unit 254 and the page priority estimation unit 255 in the information processing apparatus 200 illustrated in FIG. 4, but are different from the page movement instruction unit 254 and the page priority estimation unit 255 in the information processing apparatus 200 illustrated in FIG. 4 in portions to be referred or to give an instruction.

The under-display application monitoring unit 403, the application call probability list 404, and the application profile 405 in the information processing apparatus 400 are portions which are additionally provided to the configuration of the information processing apparatus 200 illustrated in FIG. 4.

The page movement instruction unit 401 monitors the high priority page list 258 and changes a rate for moving pages depending on the number of pages included in the high priority page list. Specifically, the page movement instruction unit changes the start or the stop of the execution of the page moving unit that is mounted as a kernel thread or the execution priority.

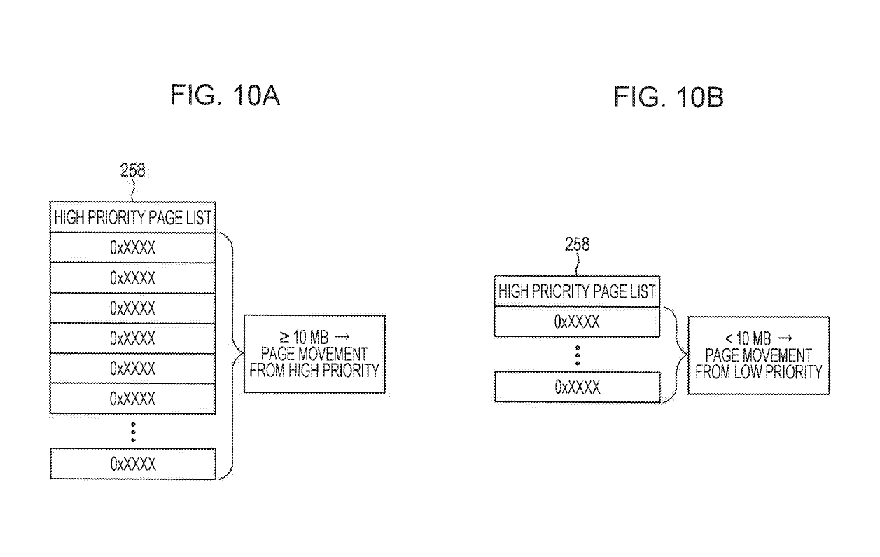

For example, if a page is registered to the high priority page list 258, the execution of the page moving unit 253 starts and when the high priority page list 258 is empty, the execution is stopped. Here, the execution priority will be described additionally with reference to FIGS. 10A and 10B.

As illustrated in 10A, a threshold value for changing the execution priority in the page movement is determined to, for example, 10 megabytes, and when pages of equal to or larger than 10 megabytes are included in the high priority page list 258, execution priority of the page moving unit 253 is raised so that a page movement process is actively executed by the kernel. In addition, as illustrated in FIG. 10B, when pages of less than 10 megabytes are included in the high priority page list 258, the execution priority of the page moving unit 253 is lowered.

The raise of the execution priority means that the page movement process is handled in the same manner as the activated application and the application and the page movement process are scheduled with the same priority. Further, the lowering of the execution priority means that the process of the activated application is preferentially performed and the application and the page movement process are scheduled with different priorities.

Further, when the execution priority is lowered, the page movement process is executed at the time when the load of the system is low, for example, the usage rate of the CPU 201 (FIG. 3) of the activated application (application that is set to have high priority) is equal to or less than 10%.

The information processing apparatus 400 illustrated in FIG. 9 has a configuration in the case of FIG. 10A and the page movement instruction unit 401 has a configuration for setting a page movement rate by referring to the high priority page list 258.

As described above, the page movement instruction unit 401 is provided to control timing for performing the page movement. The reason for controlling the timing for performing the page movement is as follows.

The reason that the information processing apparatus 400 performs the page movement during normal operation is to reduce the page movement during suspend execution. Accordingly, the more the “pages that have to be moved during suspend execution” are, the more preferable the page movement is actively performed during operation. Here, when the number of pages (amount of data) written in the high priority page list 258 is large, the pages are set to be actively moved.

If the pages are frequently moved, or the amount of data to be moved is large between the non-volatile storage unit 211 and the volatile storage unit 212, or the amount of data to be moved is large without considering the activated application process, there is a possibility of the execution rate of the information processing apparatus 200 being decreased. For example, there is a possibility of the processing rate of the activated application being lower than the processing rate of the page movement between the non-volatile storage unit 211 and the volatile storage unit 212. It is preferable that such lowering of the processing rate do not occur. Accordingly, as described above, it is preferable that the page movement process be performed at an appropriate timing by the process of the page movement instruction unit 401.

The above-described 10 megabytes is an example and the threshold value is not limited to 10 megabytes. In addition, it is possible to change a scheduling method such that only when the size of the page written in the high priority page list 258 is equal to or larger than a predetermined size, the page movement process is preferentially executed, or if the size is larger than the predetermined size, the page movement process is preferentially executed.

The description will return to the configuration of the information processing apparatus 400 illustrated in FIG. 9. When the priority of the page is determined, the page priority estimation unit 402 refers to the application call probability list 404 and the application profile 405. The details of a page priority determination method will be described later.

The under-display application monitoring unit 403 detects switching of the application being displayed on the screen. The application being displayed on the screen is changed such that the user activates a new application or changes a screen display to an application standing by in a background. The under-display application monitoring unit 403 gives a priority update indication to the page priority estimation unit 402 when the application being displayed on the screen is switched.

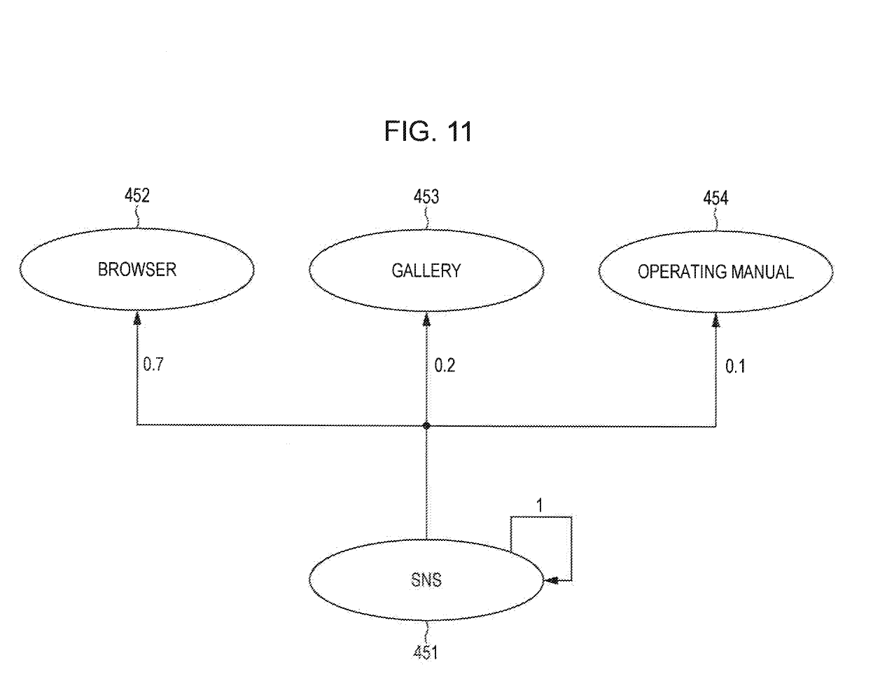

The application call probability list 404 is formed by listing information on probabilities with which a predetermined application calls other applications in a unit of application. The application call probability list 404 will be described using FIG. 11 as an example.

FIG. 11 is a view illustrating an example of a call probability list of an SNS application. The SNS application 451 is an application which is activated when a social networking service (SNS) is used and is an application for making a service to build a social network on the internet available.

A browser 452 is software for displaying and browsing information on a computer for browsing according to a predetermined purpose, and there are browsers for images, text, files on recording mediums and the like. The operation can be lightly performed by achieving specialization for browsing, or various browsing methods suitable for an object of a user can be obtained. A web page browser for browsing a page on the internet is generally used. Here, the browser 452 is regarded as a web browser and the description continues.

For example, a gallery application 453 is an application activated when photos or moving images are browsed. An operating manual application 454 is an operating manual for handling the information processing apparatus 400 and which is not a paper medium and can be browsed on a display (not illustrated) as the input and output unit 204 (FIG. 3) of the information processing apparatus 400.

When the SNS application 451 is activated, the user can use the SNS. When the SNS is used, a web address is written in the SNS in some cases. When the address is operated, the browser 452 is activated and a page of an address destination can be browsed. In a case of such a configuration, when the SNS application 451 is activated, there is a high possibility of the browser 452 being called by the SNS application 451 for activation.

In this manner, a high value is assigned to the application which has a possibility of being called from a predetermined application. In the example illustrated in FIG. 11, a value of “0.7” is assigned to the browser 452.

In the same manner, when the SNS application 451 is activated, a possibility of the gallery application 453 being called from the SNS application 451 is around a medium level, and thus, a value of “0.2” is assigned to the gallery application 453. Then, when the SNS application 451 is activated, a possibility of the operating manual application 454 being called from the SNS application 451 is low, and thus, a value of “0.1” is assigned to the operating manual application 454.

As described above, the application call probability list 404 is a list for weighting and managing possibilities of transition to a predetermined application from the executed application as numeral values. In the example illustrated in FIG. 11, the possibilities are weighted so that a total weight of all possibilities becomes “2”. In this case, since there is a high possibility that the SNS application 451 may be continuously executed, the weight of transition to itself is “1”.

Such weighting is performed in a unit of an application to be executed and managed as a list. FIG. 11 illustrates only an example, but, for example, a list of weighting applications called by the browser 452 when the browser 452 is activated, a list of weighting applications called by the gallery application 453 when the gallery application 453 is activated, and a list of weighting applications called by the operating manual application 454 when the operating manual application 454 is activated, are respectively prepared and managed.

Further, in FIG. 11, there are three applications of the browser 452, the gallery application 453, the operating manual application 454, as the applications called by the SNS application 451, but all the applications stored in the information processing apparatus 400 are managed as a list in which the probabilities of the transition to each application are written.

Such an application call probability list 404 may be formed in advance and may be formed via learning. For example, if a predetermined application is activated and there is an application called by the application, a calling probability may be calculated from total number of calling to be listed.

The description will return to the configuration of the information processing apparatus 400 in FIG. 9. The application profile 405 is a list obtained by listing the information of a page which is necessary for an application immediately after resume execution in a unit of an application. The page which is necessary for an application immediately after resume execution can be obtained by, for example, executing the application in advance and recording the page to be accessed immediately after the resume execution.

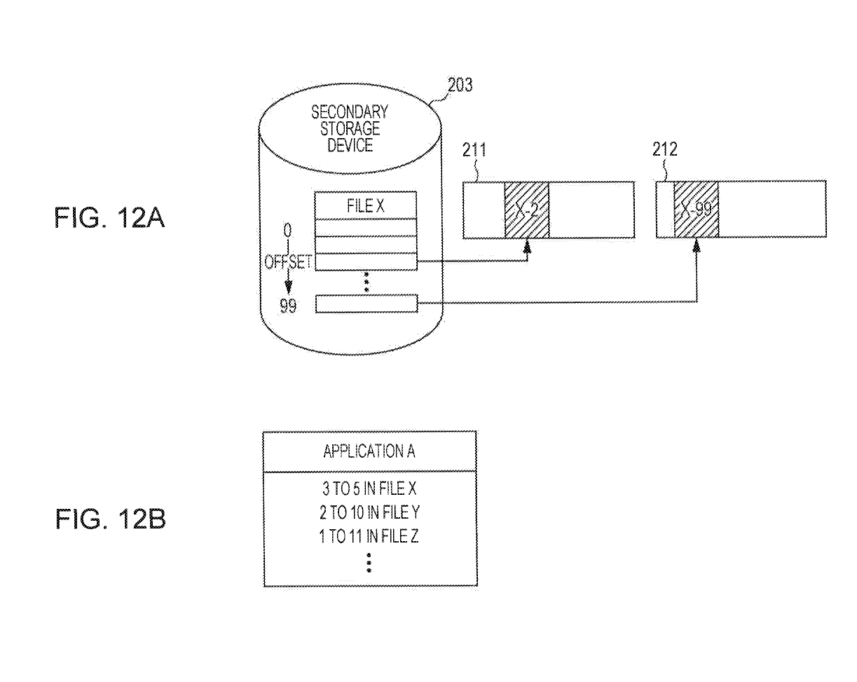

Here, page lists necessary for every application after resume execution will be described with reference to FIGS. 12A and 12B. With reference to FIG. 12A, when an application accesses to a file stored in the secondary storage device 203, the data of the file is usually copied to the main storage device 202 and such copy is referred to as a page cache.

For example, in the example illustrated in FIG. 12A, data X-2 is copied to the non-volatile storage unit 211 and data X-99 is copied to the volatile storage unit 212 from the data of a file X of the secondary storage device 203. When such a page cache is performed, the operating system stores the file and a position (offset) from which the data is read.

A page cache which is necessary immediately after resume execution is represented by setting a “file name+necessary data range” as one record. The application profile 405 is recorded as a set of records. For example, as illustrated in FIG. 12B, a list in which information of “3 to 5 in File X”, “2 to 10 in File Y”, and “1 to 11 in File Z” is written as a list regarding a predetermined application A.

As a method for obtaining a page cache necessary after such resume execution, for example, there may be a method in which a page cache to be accessed immediately after the resume execution is recorded. As other methods, existing methods may be applied.

### Priority Assignment Process in Second Embodiment

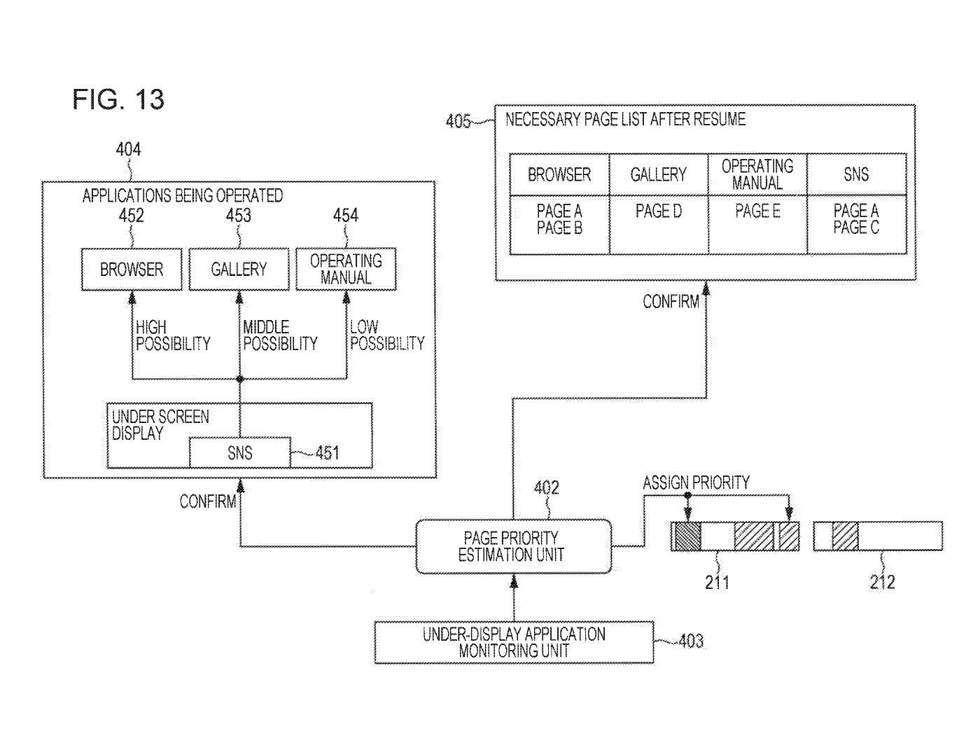

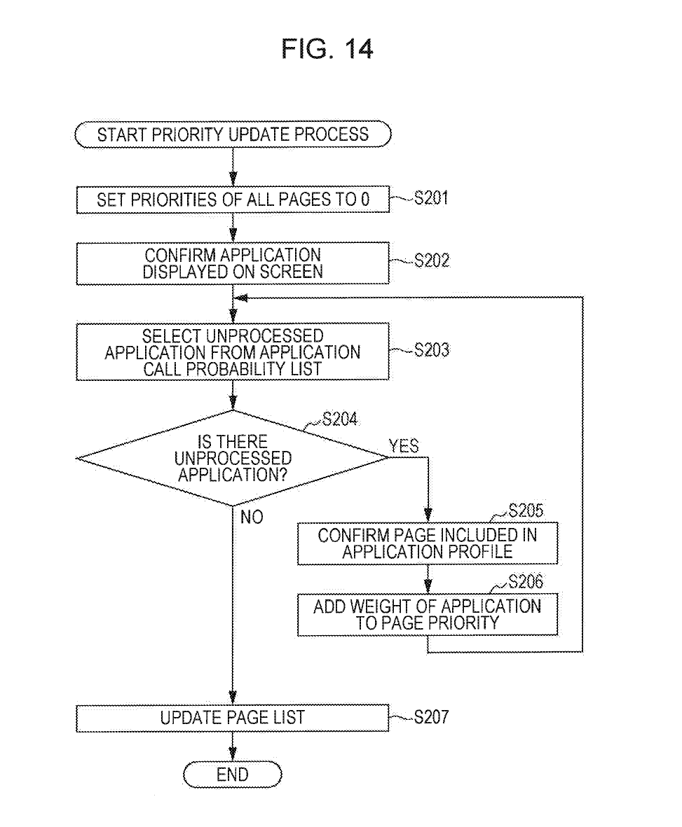

In the information processing apparatus 400 having such a configuration, as described above, the pages are stored in the non-volatile storage unit 211 or the volatile storage unit 212 depending on the priority. Here, a process related to the determination of the page priority will be described with reference to FIGS. 13 and 14.

As an example in which the page priority is updated, there is a timing at which an application being displayed on a display (not illustrated) forming the input and output unit 204 (FIG. 3) is switched. As illustrated in FIG. 13, the under-display application monitoring unit 403 monitors the application being displayed on the display and notifies, when the application being displayed is switched, the switching to the page priority estimation unit 402.

If the page priority estimation unit 402 receives the notification from the under-display application monitoring unit 403, the update of the priority starts. The update process will be described later with reference to a flowchart in FIG. 14. When the page priority is updated, the page priority estimation unit 402 confirms the application call probability list 404 and the application profile 405.

As described above, the application call probability list 404 is a list obtained by listing probabilities with which a predetermined application calls other applications and is a list in which a possibility of calling an application is determined for every application.

In addition, as described above, the application profile 405 is a list of pages which are necessary for each and every application. The page priority estimation unit 402 confirms the list and the profile to estimate the priority of each page.

When an application displayed on the screen is switched by an operation of a user or the like, an application which is being operated and is present in the main storage device 202 is confirmed. Then, the page priority is assigned based on a possibility of calling of the application and whether or not the application is necessary after resume execution.

The page priority is determined based on a sum of operation possibilities of the applications which request the page after resume execution. For example, as described with reference to FIG. 11, the operation possibility of an application being displayed on the screen is set to “1”, and the operation possibility of an application called by the application is set to a total of 1 (when the possibility is high, it is 0.7, when the possibility is middle, it is 0.2, and when the possibility is low, it is 0.1).

As a result, the page has the priority of 0 to 2. The priority of the page which is necessary for all applications is 2, the priority of the page which is necessary only for the browser 452 is 0.7, the priority of the page which is necessary only for the operating manual application 454 is 0.1, and the page which is necessary for none of the applications but is placed in the main storage device 202 now is 0.

For example, as illustrated in FIG. 13, if the priority is determined when the SNS application 451 is displayed on the screen, the browser 452 confirms that a page A and a page B are necessary after resume execution by referring to the application profile 405. When the SNS application 451 is displayed, a probability that the browser 452 is called is “0.7” but is read from the application call probability list 404. As a result, “0.7” is respectively assigned to the page A and the page B.

In the same manner, the SNS application 451 confirms that the page A and a page C are necessary after resume execution by referring to the application profile 405. When the SNS application 451 is displayed, a probability that the SNS application 451 is called “1.0” but is read from the application call probability list 404. As a result, “1.0” is respectively assigned to the page A and the page C.

“0.7” and “1.0” are assigned to the page A. Therefore, the value of the page A is “1.7”. This value is a reverence value when the priority is determined. In the same manner, the value of the page B is “0.7”, and the value of the page C is “1.0”. While the description will be omitted, a value of a page D is “0.2” and a value of a page E is “0.1” by performing the same process as the above-described process.

If such results are obtained, high priority is set in order of the descending values. Thus, in this case, the high priority is set in the order of the page A, the page C, the page B, the page D, and the page E. When the priority is set in this manner, for example, if the page A is stored in the volatile storage unit 212, the page A is written to the high priority page list 258 as a page to be stored in the non-volatile storage unit 211 with the highest priority. As a result, the page A is moved from the volatile storage unit 212 to the non-volatile storage unit 211.

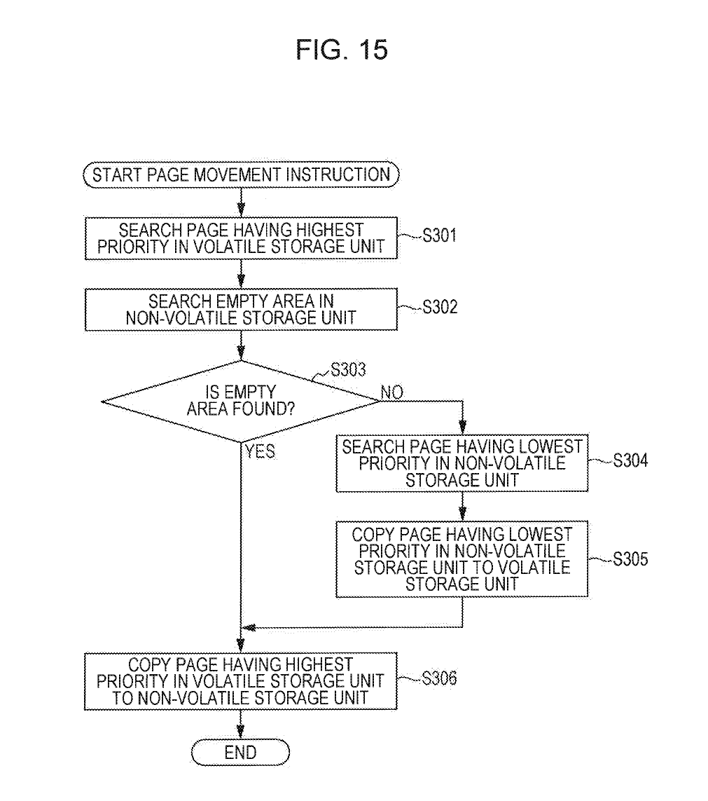

Such a process will be described again with reference to the flowcharts of FIGS. 14 and 15. First, with reference to the flowchart of FIG. 14, a priority update process will be described. The priority update process is performed at a timing at which an application being displayed on the display is switched as described above.

In Step S201, an initialization process is performed. As the initialization process, the priorities of the all pages present in the main storage device 202 are set to 0. In Step S202, the under-display application monitoring unit 403 confirms the application currently displayed on the screen and notifies the application to the page priority estimation unit 402.

In Step S203, one application is selected from the application call probability list 404. In Step S204, it is determined that whether or not there is an unprocessed application among the applications written in application call probability list 404 of the application displayed on the screen unprocessed application.

For example, as illustrated in the example of FIG. 13, if a screen by the SNS application 451 is displayed, applications regarding the SNS application 451 that are written in the application call probability list 404 are the SNS application 451, the browser 452, the gallery application 453, and the operating manual application 454. Among these four applications, whether or not there is an unprocessed application is determined in Step S204.

In Step S204, if it is determined that there is the unprocessed application, the process proceeds to Step S205. In Step S205, all the pages that are present in the main storage device 202 among pages included in the application profile 405 of an application selected as a processing target are confirmed. For example, in a case of the example illustrated in FIG. 13, if the browser 452 is selected as the processing target, the page A and the page B are confirmed as pages regarding the browser 452 by referring to the application profile 405.

In Step S206, the weight of the application selected in Step S203 is added to the page priority confirmed in the process in Step S205. For example, as described with reference to FIG. 13, when the browser 452 is selected as the processing target, “0.7” is respectively assigned to the page A and the page B and when the SNS application 451 is processed, “1.0” is respectively assigned to the page A and the page C. If “0.7” is assigned to the page A to which “1.0” has been already assigned, these values are added and the value of the page A is “1.7”.

Such processes from Steps S203 to S206 are repeated and all the applications written in the application call probability list 404 of the application being displayed on the screen are processes and thus, the priorities with respect to all pages are set.

Then, if it is determined that there is no unprocessed application in Step S204 (if the unprocessed application is not selected in Step S203), the process proceeds to Step S207. In Step S207, the page list is updated.

In Step S207, if the process with respect to all the applications included in the application call probability list 404 ends, the high priority page list 258 and the low priority page list 259 are updated. As a result of adding the weight of the application call probability list 404, the priority in a range from 0 to 2 is assigned to all pages in the in the main storage device 202.

For example, a priority of 2 is assigned to the page to which all applications are accessed after resume execution, a priority of 1 is assigned to the page to which only the SNS application 451 is accessed, and a priority of 0 is assigned to the page to which none of the applications are accessed.

When all pages are arranged in descending order of priority, a range in which the pages are stored in the capacity of the non-volatile storage unit 211 from the top, for example, if the capacity of the non-volatile storage unit 211 is 128 MB, the pages for 128 MB in descending order of priority are set as data to be finally arranged in the non-volatile storage unit 211.

The page priority estimation unit 402 gives an instruction to the high priority page list management unit 256 to register the page present in the volatile storage unit 212 among the pages in the range to the high priority page list 258. In addition, when the pages are arranged in ascending order of priority, the page priority estimation unit 402 gives an instruction to the low priority page list management unit 257 to register the page present in the non-volatile storage unit 211 among the pages stored in the volatile storage unit 212 from the top to the low priority page list 259.

In this manner, the high priority page list 258 and the low priority page list 259 are updated. After such update of the lists is performed, page movement is performed. Thus, a page movement process will be described.

The page movement process may be continuously performed after the lists are updated, and as described with reference to FIG. 10, when the number of pages managed in the high priority page list 258 or the low priority page list 259 is equal to or more than a predetermined number, or equal to or less than a predetermined number, the process may be started. Further, in addition to start timing, a page movement rate can be determined according to the number of pages managed in the high priority page list 258 or the low priority page list 259 as described with reference to FIG. 10 to perform the process.

FIG. 15 is the flowchart for illustrating the page movement process.

In Step S301, the page moving unit 253 selects the page having the highest priority as a movement target among the pages present in the volatile storage unit 212 by referring to the high priority page list 258. In Step S302, the page moving unit 253 searches an empty page (empty capacity) in the non-volatile storage unit 211 which is a movement destination.

In Step S303, it is determined whether or not an empty page is found in the non-volatile storage unit 211. In Step S303, if it is determined that the empty page is not found in the non-volatile storage unit 211, the process proceeds to Step S304. In this case, since the empty page is not found in the non-volatile storage unit 211, the page movement is difficult. Thus, a process of forming an empty page in the non-volatile storage unit 211 is executed. If the empty page is not found, the empty page is formed by moving the page having low priority in the non-volatile storage unit 211 to the volatile storage unit 212.

In Step S304, the page moving unit 253 selects the page having the lowest priority in the non-volatile storage unit 211 by referring to the low priority page list 259. In Step S305, the page moving unit 253 copies the data of the page selected in the process in Step S304 to the empty page in the volatile storage unit 212.

Then, the page moving unit 253 gives an instruction to the page table management unit 252 to update the page table so that the virtual address referred to the page selected the process in Step S304 is associated with the copied data in the volatile storage unit 212. Finally, a source area selected in the process in Step S304 is considered as an empty area.

In this manner, when the empty area is formed in the non-volatile storage unit 211, or in Step S303, if it is determined that there is the empty area in the non-volatile storage unit 211, the process proceeds to Step S306.

In Step S306, the page moving unit 253 copies the page selected in the process in Step S301 to the empty page in the non-volatile storage unit 211. Then, the page moving unit 253 gives an instruction to the page table management unit 252 to update the page table so that the virtual address referred to the page selected the process in Step S301 (page copied to the non-volatile storage unit 211) is associated with the copied data in the non-volatile storage unit 211. Finally, a source area selected in the process in Step S301 is considered as an empty area.

In this manner, the page movement is performed according to the set priority. The page movement is performed during the operation of the information processing apparatus 400 (when the power is supplied to the volatile storage unit 212 to be operated).

The suspend process can be performed as a process based on the flowchart illustrated in FIG. 7 as in the first embodiment. The description of the flowchart illustrated in FIG. 7 has been already made and thus, the description will be omitted here.

Since such a page movement has not been performed in the related art, when the instruction for the suspend process has been given, the page to be saved has been saved at a time point when the suspend process starts. However, as described above, according to the embodiment, the page is saved at a time point before the instruction for the suspend process is given. Thus, the page saving operation can almost end at the time point when the suspend process starts.

As described above, according to the present technology, it is possible to shorten time for the suspend process. In addition, a time for the suspend process can be shortened and thus, a power saving effect can be expected.

### Regarding Other Configurations

In the above-described embodiments, as for the timing at which the priority of the page is changed, the start or the end of a predetermined application (switching of the application displayed on the screen) has been described as an example. The priority of the page is changed when a specific event in which a pattern of the page to be accessed by the system after resume execution significantly changes occurs. As the specific event, activation of an application and a screen display have been used as examples.

Additionally, as events in which the page priority changes, there are events as follows. When the following events occur, the page priority can be updated. A predetermined event includes an event in which a status that is used by the system to manage the application changes and, for example, there may be the activation or end of the application, during the execution or interruption of the application, a foreground, a background and the like.

In addition, there are an event in which the application itself notifies a change in the inner state to the system, for example, events such as switching of a mode, a start or end declaration for use of a device, and the like.

When these events occur, the above-described page priority can be updated. All these events are set as targets and when at least one of the events occurs, the page priority can be updated. In addition, one or plural events among the events is or are set in advance, and when the set event occurs, the page priority can be updated.

As the events, start of a standby mode will be described as an example. The standby mode is a mode, for example, in a reception standby state in a mobile phone or the like. The application declares to call a predetermined function to enter the “standby mode”. This declaration is set as the event.

The application which is operated in the standby makes the system be resumed regularly during the suspend execution and has a function for confirming whether or not there is information to be processed, for example, a new arrival mail. Accordingly, the page used by the application has a high possibility of being accessed immediately after the resume execution. When the page priority is determined, the page used by the application in the “standby mode” can have high priority.

Next, as the event, end of a predetermined device will be described as an example. The application declares to call a predetermined function to end use of a specified device. For example, when an application for uploading photos ends the use of Wi-Fi, it is declared that the use of the device related to Wi-Fi is ended.

The declaration that the use of the predetermined device is ended is set as the event. It is possible to determine that the application which has made the declaration does not actively perform a process for a while. Therefore, the page used by the application has a low possibility of being used immediately after the resume execution. Accordingly, when the page priority is determined, the priority of the page used by such an application can be set to be low.

Further, other page priority setting methods will be described. For example, when environmental changes which change a probability to execute an application occur inside or outside the system, the priority is updated or the priority of the page used by the application can be set to be high. For example, as the environmental changes inside or outside the system, there are a change in position, a change in system settings, a change in a network state, a change in time and the like.

First, a case in which the change in position is recognized as the event to set the page priority will be described. The positional information is attached to a frequently used application. For example, the information processing apparatus 400 is a portable terminal and is a terminal which is used in an office or at home. For example, when the information processing apparatus 400 is used in the office, an application regarding text input is activated, and when the information processing apparatus is used at home, an application for browsing the internet is activated in most cases. Depending on the position of the information processing apparatus 400, a certain degree of rule is found in the activated application.

If there is such a degree of rule, the change in positional information is set as the event and the page priority can be set. For example, using a Global Positioning System (GPS), the positional information is obtained from the GPS. Then, it can be estimated that an application attached to the position indicated by the positional information has a high possibility of being executed in the near future based on the positional information obtained from the GPS. Here, when the page priority is determined, the priority of the page used by the application is set to be high. Contrarily, when it is determined that a predetermined application is shifted from a frequently used area, the priority of the page used by the application can be set to be low.

Next, a case in which the change in system settings is recognized as the event to set the page priority will be described. A mode change by the user is set as the event. For example, the user switches the mode to a “high speed activation mode of a camera” in the setting. In the high speed activation mode of a camera, the page is usually retained in the non-volatile storage unit 211 so that only an application regarding a camera can be activated at a high speed even immediately after resume execution. If the mode is set to the “high speed activation mode of a camera”, when the page priority is determined, the priority of the page used by the application regarding the camera can be set to be high.

Next, a case in which the change in a network state is recognized as the event to set the page priority will be described. The connection or disconnection of the network is set as the event. For example, the network connection of the system is cut. The communication through the network is not possible, and thus, it is difficult to operate an application which asks for the communication through the network. When the page priority is determined in such a state, the priority of the page used by the application which asks for the communication through the network can be set to be low.

The information processing apparatus 400 can be configured by the methods of setting the timings at which the page priority is updated and the page priority.

Further, it is possible to provide a mechanism in which a page placed in the non-volatile storage unit 211 or a page placed in the volatile storage unit 212 can be explicitly designated by an application. For example, the application can call a predetermined function to fix an area which asks for time for initialization to the non-volatile storage unit 211, or can designate an area which is used as a buffer and in which the content may disappear for being placed in the volatile storage unit 212.

Furthermore, the application may give an instruction not to perform a page movement process for a predetermined period of time. For example, when a predetermined application tries to access to a wide range of memory, the application can call a predetermined function to request temporary stop of the page movement process.

In this manner, according to the present technology, it is possible to shorten time for the suspend process. In addition, a power saving effect can be expected by shortening time for a suspend process.

In addition, according to the present technology, since the page (data) necessary after resume execution is stored in the non-volatile storage unit 211, it is possible to shorten time until restoration.

Further, since, even immediately after the restoration, the page with a high possibility of being necessary during resume execution is already stored in the non-volatile storage unit 211, the process of moving the page from the secondary storage device 203 to the volatile storage unit 212 is not necessary and the operation can be started immediately after restoration. Therefore, it is possible to increase the operation rate immediately after the restoration.

In addition, if the process of moving the page from the secondary storage device 203 to the volatile storage unit 212 is necessary, the page stored in the secondary storage device 203 has a low possibility of being necessary during resume execution, and thus, the process can be started by using the page stored in the non-volatile storage unit 211. Then, after the process starts, even if the page is moved from the secondary storage device 203 to the volatile storage unit 212 as necessary, the process is not delayed. Therefore, it is possible to increase the operation rate immediately after the restoration.

Further, according to the present technology, since the page that is necessary for the application being operated is stored in the non-volatile storage unit 211, the operation of the volatile storage unit 212 can be stopped. Since it is possible to stop the power supply to the volatile storage unit 212 by stopping the operation of the volatile storage unit 212, power saving can be realized. That is, a power saving mode can be realized by applying the present technology.

### Regarding Recording Medium

The above-described series of processes can be executed either by hardware or by software. When the series of processes is executed by software, programs constituting the software are installed in a computer. Here, the computer includes a computer which is built in dedicated hardware or, for example, a general-purpose personal computer in which various programs are installed to execute various functions.

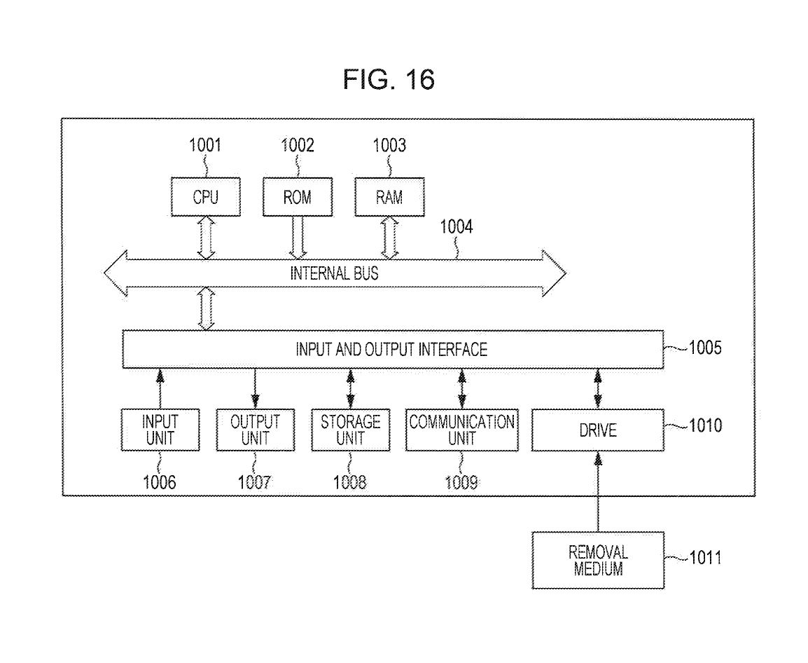

FIG. 16 is a block view illustrating a configuration example of hardware of a computer which executes the above-described series of processes by the programs. In the computer, a central process unit (CPU) 1001, a read only memory (ROM) 1002, and a random access memory (RAM) 1003 are connected through a bus 1004. Further, an input and output interface 1005 is connected to the bus 1004. An input unit 1006, an output unit 1007, a storage unit 1008, a communication unit 1009, and a drive 1010 are connected to the input and output interface 1005.

The input unit 1006 includes a keyboard, a mouse, a microphone, and the like. The output unit 1007 includes a display, a speaker, and the like. The storage unit 1008 includes a hard disk, a non-volatile memory, and the like. The communication unit 1009 includes a network interface and the like. The drive 1010 drives a removable medium 1011 such as a magnetic disk, an optical disc, a magneto-optical disc, a semiconductor memory, and the like.

In the computer having such a configuration, the CPU 1001 executes the above-described series of processes, for example, by loading and executing the program stored in the storage unit 1008 on the RAM 1003 through the input and output interface 1005 and the bus 1004.

For example, the program executed by the computer (the CPU 1001) can be recorded in the removable medium 1011 as a package medium for supply. Further, the program can be supplied through a wired or wireless transmission medium such as a local area network, the Internet, or digital satellite broadcast.

In the computer, the program can be installed on the storage unit 1008 through the input and output interface 1005 by mounting the removable medium 1011 on the drive 1010. In addition, the program can be received by the communication unit 1009 through a wired or wireless transmission medium and can be installed on the storage unit 1008. Further, the program can be installed in advance on the ROM 1002 or the storage unit 1008.

The program executed by the computer may be a program that is processed chronologically in the order described in the specification or a program that is processed in parallel or at a necessary timing when called.

In the specification, the system indicates the entire apparatus including plural apparatuses.

Embodiments of the present technology are not limited to the above-described embodiments, but may be modified in various forms without departing from the gist of the present technology.

The present technology may be configured as follows.

(1) An information processing apparatus including: a main storage device, wherein the main storage device includes a non-volatile storage unit and a volatile storage unit, and a page is moved between the non-volatile storage unit and the volatile storage unit at a predetermined timing based on a priority that is assigned to the page.

(2) The information processing apparatus according to (1), wherein a page placed in the non-volatile storage unit is a page that has a high possibility of being accessed after resume execution.

(3) The information processing apparatus according to (1) or (2), further including: a first list for managing priorities of pages having a high possibility of being accessed after resume execution; and a second list for managing priorities of pages having a low possibility of being accessed after resume execution.

(4) The information processing apparatus according to (3), wherein the first list is stored in the volatile storage unit but is a list for managing high priority pages to be moved to the non-volatile storage unit, and the second list is stored in the non-volatile storage unit but is a list for managing high priority pages to be moved to the volatile storage unit.

(5) The information processing apparatus according to (3) or (4), wherein the first list and the second list are updated when an event in which a system state changes occurs.

(6) The information processing apparatus according to (5), wherein the event is at least one event of activation or end of a predetermined application, start or end of use of a predetermined device, switching to a predetermined mode, a change in positional information, and a change in a network connection state.

(7) The information processing apparatus according to (5) or (6), wherein the predetermined timing is a timing at which the first list and the second list are updated.

(8) The information processing apparatus according to any one of (3) to (7), further including: a third list for managing probabilities that a predetermined application calls other applications; and a profile for managing page information necessary for a predetermined application after resume execution, wherein when a screen by a first application is changed to a screen by a second application, the profile is referred to confirm a page necessary for the second application after resume execution, and the third list is referred to assign a probability of the second application to the confirmed page, and the first list and the second list are respectively updated based on a value of the probability assigned to the page.

(9) The information processing apparatus according to (3) to (8), wherein a page movement frequency between the non-volatile storage unit and the volatile storage unit is changed according to the number of pages written in the first list or the second list.

(10) An information processing method of an information processing apparatus that includes a main storage device having a non-volatile storage unit and a volatile storage unit, the method including: moving a page between the non-volatile storage unit and the volatile storage unit at a predetermined timing based on a priority that is assigned to the page.

(11) A computer-recording recording medium having a program recorded therein, the program causing a computer, which controls an information processing apparatus that includes a main storage device having a non-volatile storage unit and a volatile storage unit, to execute a process including: moving a page between the non-volatile storage unit and the volatile storage unit at a predetermined timing based on a priority that is assigned to the page.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a main storage device,
wherein the main storage device includes a non-volatile storage unit and a volatile storage unit, and
a page is moved between the non-volatile storage unit and the volatile storage unit at a predetermined timing based on a priority that is assigned to the page.

2. The information processing apparatus according to claim 1,
wherein a page placed in the non-volatile storage unit is a page that has a high possibility of being accessed after resume execution.

3. The information processing apparatus according to claim 1, further comprising:
a first list for managing priorities of pages having a high possibility of being accessed after resume execution; and
a second list for managing priorities of pages having a low possibility of being accessed after resume execution.

4. The information processing apparatus according to claim 3,
wherein the first list is stored in the volatile storage unit but is a list for managing high priority pages to be moved to the non-volatile storage unit, and
the second list is stored in the non-volatile storage unit but is a list for managing high priority pages to be moved to the volatile storage unit.

5. The information processing apparatus according to claim 3,
wherein the first list and the second list are updated when an event in which a system state changes occurs.

6. The information processing apparatus according to claim 5,
wherein the event is at least one event of activation or end of a predetermined application, start or end of use of a predetermined device, switching to a predetermined mode, a change in positional information, and a change in a network connection state.

7. The information processing apparatus according to claim 5,
wherein the predetermined timing is a timing at which the first list and the second list are updated.

8. The information processing apparatus according to claim 3, further comprising:
a third list for managing probabilities that a predetermined application calls other applications; and
a profile for managing page information necessary for a predetermined application after resume execution,
wherein when a screen by a first application is changed to a screen by a second application, the profile is referred to confirm a page necessary for the second application after resume execution, and the third list is referred to assign a probability of the second application to the confirmed page, and
the first list and the second list are respectively updated based on a value of the probability assigned to the page.

9. The information processing apparatus according to claim 3,
wherein a page movement frequency between the non-volatile storage unit and the volatile storage unit is changed according to the number of pages written in the first list or the second list.

10. An information processing method of an information processing apparatus that includes a main storage device having a non-volatile storage unit and a volatile storage unit, the method comprising:
moving a page between the non-volatile storage unit and the volatile storage unit at a predetermined timing based on a priority that is assigned to the page.

11. A computer-recording recording medium having a program recorded therein, the program causing a computer, which controls an information processing apparatus that includes a main storage device having a non-volatile storage unit and a volatile storage unit, to execute a process comprising:
moving a page between the non-volatile storage unit and the volatile storage unit at a predetermined timing based on a priority that is assigned to the page.
